(19) United States
(12) Patent Application Publication
(10) Pub. No.: US 2009/0289422 A1
(43) Pub. Date: Nov. 26, 2009

(54) Packing ring combination

(75) Inventors: Tino Lindner-Silwester, Wien (AT); Christian Hold, Wien (AT); Alexander Jandl, Rohrendorf (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: HOERBIGER KOMPRESSORTECHNIK HOLDING GMBH

(21) Appl. No.: 12/292,220

(22) Filed: Nov. 13, 2008

(30) Foreign Application Priority Data
Nov. 15, 2007 (AT) A1853/2007

(51) Int. Cl. F16J 15/18

(52) U.S. Cl. 277/511

(57) ABSTRACT

Conventional combinations of radially and tangentially cut packing rings require, in particular as wear progresses, a degree of resilient deformation of the resilient packing ring, in order to be able to achieve a satisfactory sealing effect. However, the level of wear achievable is limited thereby. On the other hand, sealing rings which offer a high level of wear and a long service life due to the cut arrangement wear in an uncontrolled manner, which is associated with a risk of damage to or destruction of the sealing rings, resulting in the need for regular maintenance and replacement of the sealing rings. These problems are avoided by a packing ring combination according to the invention consisting of multi-part sealing ring 12 and stop ring 20, in that an axial shoulder 16 is provided on the sealing segments 14 of the sealing ring 12, which shoulder at least partially overlaps the stop ring 20 in the axial direction, and the axial shoulder 16 is arranged at a distance from the stop ring 20 in the radial direction, such that the axial shoulder 16 rests against the stop ring 20 once the sealing segments 14 have been worn by a given amount, whereby a wear limit or wear retardation is achieved.

The present invention relates to a packing ring combination with a sealing ring consisting of a number of sealing and back-up segments, the sealing and back-up segments being arranged next to one another alternately in the circumferential direction to form a ring, and with a stop ring which rests axially against the sealing ring, and to a pressure packing and to a seal with such a packing ring combination.

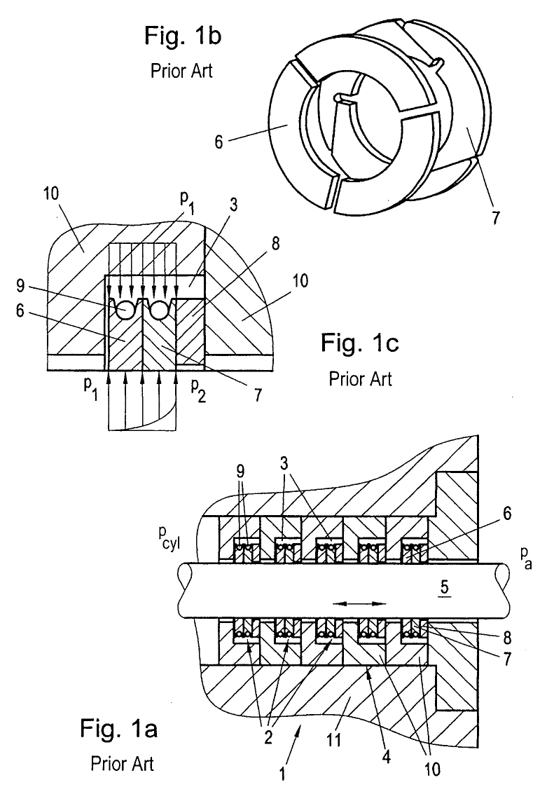

Piston compressors, in particular of double-acting construction, require sealing of the crank-side compression chamber in the cylinder, in which the (high) cylinder pressure p_{cyl} variable over time prevails, along the oscillating piston rod 5. This sealing has typically to proceed against the (low) ambient pressure pₐ prevailing in the crankcase. The sealing elements which are used for such a seal 4 are known as packing rings 6, 7 and are arranged in a “pressure packing” 2, consisting as a rule of a number of packing rings 6, 7, as illustrated by way of example in a conventional embodiment in FIG. 1. The sealing elements may then follow unavoidable lateral movements of the piston rod 5 without losing their sealing effect. To increase the service life and reliability of a pressure packing 2, a plurality of such packing rings 6, 7 are connected in series in a pressure packing 2, with a plurality of pressure packings 2 as a rule being arranged in succession to form a seal 4. Such pressure packings 2 or seals 4 are sufficiently well known from the prior art in a very wide range of configurations, e.g. from GB 928 749 A or U.S. Pat. No. 1,008,655 A.

Packing rings 6, 7 are self-activating seals, which need as a rule a certain pressure differential p₁-p₂ requiring sealing for a sufficient sealing effect to be achieved, i.e. sufficiently low leakage (FIG. 1c). The gas pressure in a packing chamber 3 breaks down in the gaps to be sealed of a packing ring 6, 7 from the higher level p₁ to the lower level p₂ in the next packing chamber 3. FIG. 1c is a schematic diagram of this pressure breakdown in the sealing gap formed between packing ring 6, 7 and piston rod 5. This sealing gap has a significant part to play with regard to the performance of the packing rings 6, 7, since the relative motion of the contact surfaces between piston rod 5 and rings 6, 7 causes wear to the packing rings 6, 7. This ring wear generally requires cut ring types, which enable automatic, continuous readjustment of the ring in the event of material abrasion at this ring/piston rod sealing gap. Standard in the industry are radially and tangentially cut rings 6, 7, which are used in pairs in packing chambers of the pressure packing in order to cover one another at the butt gaps arising for the purpose of wear compensation, as shown schematically in FIG. 1b. Such combinations of radially/tangentially cut rings are single-acting seals, which seal only in the direction of the crosshead, while in the course of the crank-side reexpansion phase of the piston compressor 1 the radial cuts ensure that no relatively high pressure can be trapped in the packing. In the case of cut ring types, it is known conventionally to use garter springs (circumferential springs) 9 wound over the outer circumference, which springs press the packing rings 6, 7 against the piston rod 5 even in the unpressurized state.

At higher pressures in particular, with conventional arrangements significant extrusion of the packing rings 6, 7 into the gap formed between piston rod 5 and packing housing or chamber disc 10 may occur. In order very largely to avoid this extrusion, additional metal back-up rings 8 not in extensive contact with the piston rod 5 may be used between the ring on the low pressure side and the chamber disc 10, as disclosed for example in U.S. Pat. No. 3,305,241 A.

In a combination of a radially and a tangentially cut packing ring, sealing relative to the piston rod is effected substantially only by the tangentially cut packing ring, whose ring segments may be pushed together under wear due to the tangential cut arrangement and thus maintain the sealing effect. The radially cut packing ring serves substantially only to seal the wear gaps of the tangential packing ring in the axial and radial directions and is subject to low wear only in the running-in phase. The radial packing ring is then worn only until the ring segments lie against one another in the circumferential direction. The radially and tangentially cut packing rings thus wear differently. In addition to the circumstance that the tangentially cut ring always wears faster due to greater surface pressure than the radially cut ring, the tangential ring is typically also subject to uneven wear in the circumferential direction, which may be accompanied by opening of the tangential cuts and thus significantly increased leakage. Thus, such a ring may lose the majority of its sealing effect even if it has not yet reached its wear limit (brought about by the wear compensation gap). Furthermore, under increasing wear a packing ring combination of radially and tangentially cut packing rings requires resilient deformation of the ring segments, in order to be able to maintain the sealing effect. Thus, the only materials feasible for such packing ring combinations are those which allow appropriate resilient deformation.

JP 05-044850 A1 has already proposed the use of a six-part sealing ring, which comprises three sealing segments, which form a continuous sealing surface radially on the inside. The sealing segments rest against wedge-shaped back-up segments arranged therebetween. When the sealing segments are worn, the sealing segments move radially inwards and in so doing slide over the back-up segments, which remain in substantially the same position. Such a sealing ring may therefore be subject to very considerable wear without losing its sealing effect. The problem with this, however, is that the sealing ring has to be changed in good time, before the sealing segments wear away too much and are thereby possibly damaged or even destroyed by the mechanical and/or thermal loading. Since the actual wear cannot be detected from outside, however, the seal has to be checked regularly, which is generally also accompanied by (premature) replacement of the sealing rings. The service life of the sealing rings may therefore possibly not be optimally utilized.

It is consequently an object of the present invention to remedy the above-stated problems, in particular to provide a sealing ring which may nonetheless be subject to very considerable wear and make optimum use of the available wear potential.

This object is achieved according to the invention in that an axial shoulder is provided on the sealing segments of the sealing ring, which shoulder at least partially overlaps the stop ring in the axial direction, and the axial shoulder is arranged at a distance from the stop ring in the radial direction, such that the axial shoulder rests against the stop ring once the sealing segments have been worn by a given amount. As wear of the sealing ring increases, the sealing segments move radially inwards, the radial spacing allowing a running-in phase with unhindered wear. Maintenance of the sealing effect is based, in the case of the embodiment according to the invention, on the fact that no resilient deformation is necessary with increasing wear as in the case of conventional radially/tangentially cut rings and thus the opening up of leakage gaps or paths may be prevented. Because maintenance of the sealing effect is not based on any resilient deformation, this design is also very particularly suitable for high performance plastics such as polyimide for example, which combines the best frictional and wear characteristics with high mechanical strength and rigidity as well as heat resistance. The embodiment according to the invention of the sealing ring is additionally exceptionally insensitive to dimensional variations during manufacture. Variations in the widths of the individual segments lead only to small radial shifts of the sealing and back-up segments and the single essential dimension with regard to maintaining an elevated sealing effect is the thickness of the segments in the axial direction, which is easy to produce highly accurately. The sealing segments can thus wear over a very large area. At the same time, the cooperation between the axial shoulder and the stop ring ensures that a wear limit is present, which prevents further wear beyond a critical amount. The sealing effect is thus maintained to a sufficient degree.

It is very particularly advantageous when the two end faces, viewed in the circumferential direction, of a sealing segment are arranged parallel to one another. As a result of such a cut arrangement, a kinematic situation is achieved in which the back-up segments retain their position in an advantageous embodiment while the sealing segments move radially inwards. In this way it may be ensured that it is only ever the sealing segments which rest against the component to be sealed and consequently only the sealing segments which become worn. In the case of sealing segments with parallel end faces, it is additionally advantageous to arrange an optional antirotation element in a back-up segment, since these remain in position and the antirotation element is thus not subject to substantially any shear stress.

It is particularly advantageous if the two end faces, viewed in the circumferential direction, of a sealing segment are bevelled radially on the inside, since in this way the sealing segments are made less sensitive to damage during transportation or installation. Installation of the sealing ring in a packing housing may additionally be simplified thereby.

Advantageously a radially cut packing ring is provided, which rests axially against the sealing ring on the axial end face of the sealing ring facing the high pressure. The distinctive feature of this design consists in the fact that the sealing ring, which is pressed, due to the relatively low gas pressure in the sealing gap, with greater force than the radially cut packing ring against the component to be sealed and is thus also subject to greater wear, may suffer considerable material abrasion at its internal diameter without losing its sealing effect. Due to this forced symmetrical wear to the sealing segments, the sealing ring material is optimally utilized and a maximum service life is achieved with a given rate of wear, while on the other hand the service life of the sealing ring may be extended by a simple increase in the radial height of the sealing segments.

In one advantageous development, the axial shoulder is provided on the side of the sealing ring facing the low pressure. The stop ring may then be either rigid or resilient. The stop ring may, for this purpose, take the form of a rigid back-up ring, which rests axially against the sealing ring on the low pressure side and which is surrounded at least in part by the axial shoulder, or of a resilient ring, which rests axially against the sealing ring on the low pressure side and which is surrounded at least in part by the axial shoulder. When a rigid back-up ring is used, a resilient ring may also be arranged between axial shoulder and back-up ring. When a rigid stop means is used, a defined wear limit is obtained, after which further wear is only possible by way of resilient deformation of the sealing segments. When a resilient stop means is used, wear retardation can be established, such that the rate of wear reduces gradually. Where tightness requirements are stringent, it is more advantageous to provide wear retardation, whereas when tightness requirements are less stringent a wear limit may be sufficient. Common to both variants is the long service life provided by the large available wear area.

Alternatively, the axial shoulder may also be provided on the side of the sealing ring facing the high pressure. The stop ring may then advantageously be the radially cut packing ring itself or a rigid back-up ring on the high pressure side, which rests axially against the sealing ring. Use of the radially cut packing ring as a stop means is very particularly advantageous, since then the sealing ring and the radially cut packing ring arranged upstream thereof wear at the same rate after a given radial wear of the sealing ring, which may be set as desired. The problem of the sealing ring always wearing more rapidly than the radially cut packing ring arranged upstream thereof is thus eliminated and the available ring material is utilized optimally for wear. Wear retardation may consequently also be achieved thereby.

The present invention is described below with reference to the schematic FIGS. 1 to 9 showing exemplary, non-limiting, advantageous developments. In the Figures

FIG. 1 shows known sealing of a piston rod with radially and tangentially cut packing rings,

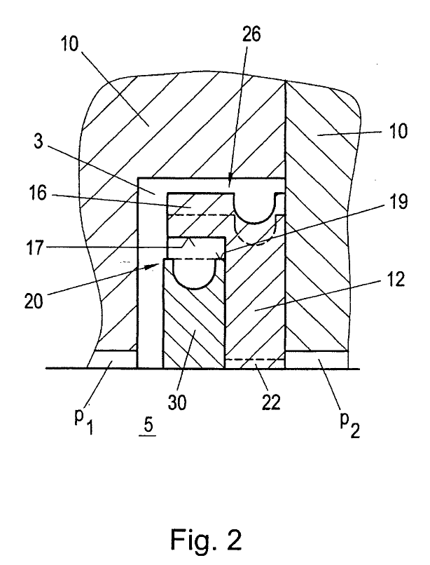

FIGS. 2 and 3 show an advantageous arrangement of a packing ring combination or a pressure packing,

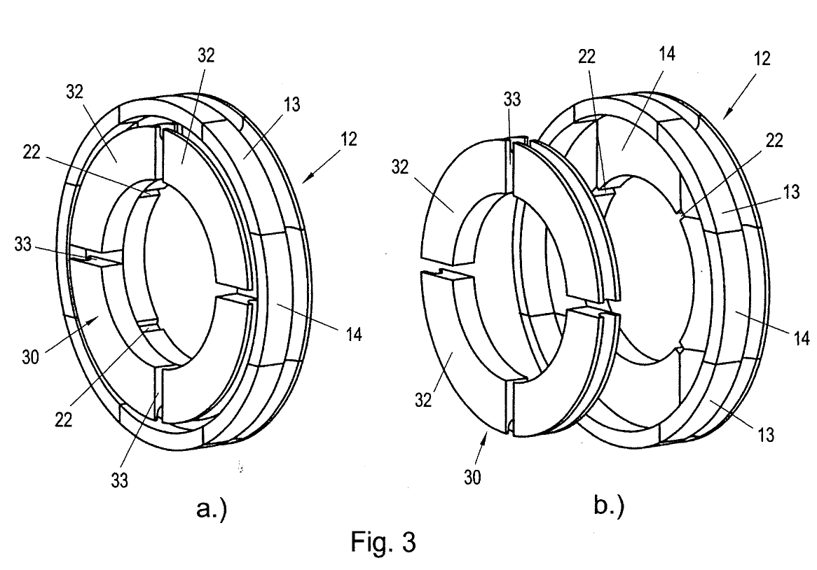

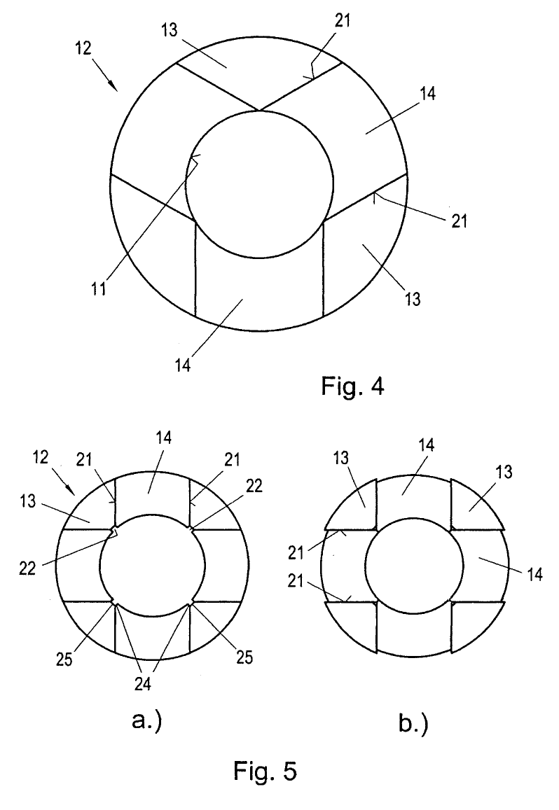

FIGS. 4 and 5 show advantageous developments of a sealing ring of a packing ring combination according to the invention with bevelled edges and

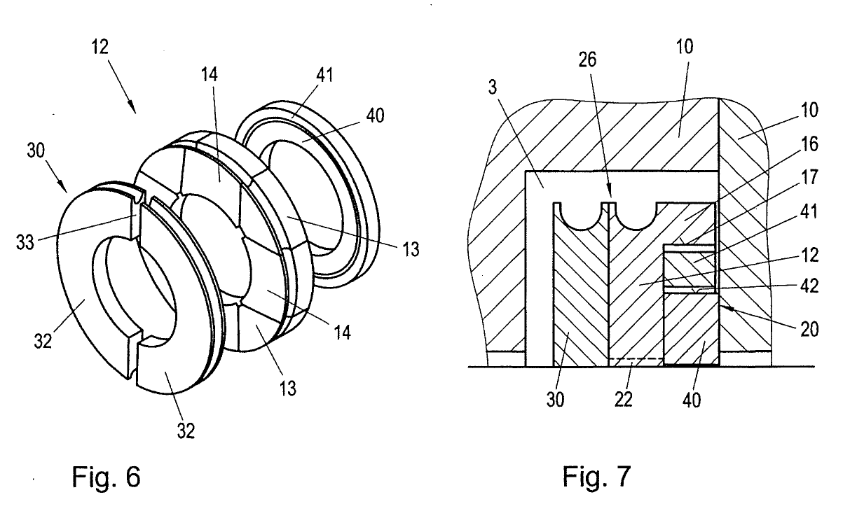

FIGS. 6 to 9 show further advantageous developments of a packing ring combination or a pressure packing.

With reference to FIGS. 2 and 3, a development will be described of a packing ring combination according to the invention of a pressure packing 26, e.g. a seal for a piston rod 5 of a compressor. The pressure packing 26 is here arranged in a packing chamber 3 of a packing housing (e.g. formed by adjoining chamber discs 10) and here provides a seal between a side with a high pressure p₁ and a side with a low pressure p₂. Sealing in this context means that the high pressure p₁ is broken down by the pressure packing 26 or the packing ring combination to the low pressure p₂. The packing ring combination consists of a sealing ring 12, which in this example is of eight-part construction, and a stop ring 20. The sealing ring 12 comprises an axial shoulder 16, here in the radially outer area of the sealing ring 12 and facing the side with the high pressure p₁. This axial shoulder 16 may here be arranged solely on the sealing segments 14 or on both the sealing segments 14 and the back-up segments 13. The sealing ring 12 lies with the opposing, low-pressure-side axial end face against the wall of the packing housing 10 and so provides a seal in the radial direction against the high pressure p₁ acting in the packing chamber 3. The stop ring 20 takes the form in this example of a radially cut packing ring 30 and lies axially against the sealing ring 12 on the high pressure side. The axial shoulder 16 of the sealing ring 12 thus at least partially overlaps the stop ring 20 in the axial direction. The inner circumferential surface 17 of the axial shoulder 16 and the outer circumferential surface 19 of the stop ring 20 are here arranged at a distance from one another in the radial direction, the stop ring 20 being arranged radially on the inside relative to the circumferential surface 17 of the axial shoulder 16. The stop ring 20 could however also be embodied by a rigid back-up ring instead of a radially cut packing ring 30, which rigid back-up ring rests axially against the sealing ring 12 on the high pressure side. The axial shoulder 16 of the sealing ring 12 would then come to lie against the outer circumferential surface of the back-up ring after a certain amount of wear.

A six-part sealing ring 12 is illustrated in FIG. 4 and comprises in this exemplary embodiment in each case three sealing segments 14 and three back-up segments 13, which are arranged lying alternately against one another in the circumferential direction and form a ring. Radially to the inside there arises a continuous circular circumferential surface 11, which at the same time forms the sealing surface relative to the component to be sealed, here for example the piston rod 5. The high pressure p₁ is broken down to the low pressure p₂ along this sealing surface. At the radially outer circumferential surface of the sealing ring 12 or the sealing segments 14 and the back-up elements 13 it is possible, in a known manner, to provide a recess for accommodating a circumferential spring 9.

The two end faces 21, viewed in the circumferential direction, of the sealing segments 14 are preferably parallel to one another. Upon wear of the sealing segments 14, whereby the sealing segments 14 are advanced radially inwards by the radially externally acting high pressure p₁, the back-up elements 13 thereby remain substantially in position and the sealing segments 14 slide radially inwards over the back-up segments 13. Thus, only the sealing segments 14 wear. It goes without saying that the two end faces of a sealing segment 14 may also be at an angle to one another. In such an arrangement, the back-up segments 13 may however also be moved in the radial direction by wear of the sealing segments 14. It must therefore be ensured in such an embodiment, for example by constructional design of the back-up segments 13, that the inner circumferential surface 11 remains closed, in order to be able to maintain the sealing effect of the sealing ring 12.

To prevent damage to the edges of the sealing segments 14 on the sealing surface side, e.g. during installation or during transportation, provision may be made for the end faces 21, viewed in the circumferential direction, of the sealing segments 14 to be bevelled radially on the inside, e.g. by a radial cut 24, as illustrated in FIG. 5 by means of an eight-part sealing ring 12. The back-up segments 13 may likewise be bevelled radially on the inside, e.g. by a tangential cut 25. Upon installation of the sealing ring 12, the sealing segments 14 are compressed by the circumferential spring 9 to a predetermined internal diameter, which is defined by the bevel of the sealing segments 14, and rest against one another at the bevels, whereby a defined installation situation is achieved.

However, the bevels result in an axial gap 22, which would destroy the sealing effect of the sealing ring 12. In such a development, sealing of these axial gaps 22 is thus necessary. According to the invention, a radially cut packing ring 30 may be arranged for this purpose on the high pressure p₁ side to seal this gap 22, which packing ring rests axially against the sealing ring 12. Such an advantageous arrangement is illustrated in FIGS. 2 and 3 and described below.

The radially cut packing ring 30, in this case at the same time the stop ring 20, is here arranged in the axial recess formed by the axial shoulder 16 and rests axially against the sealing ring 12. The radially cut packing ring 30 is thus at least partially enclosed in the circumferential direction by the axial shoulder 16. As wear to the sealing segments 14 progresses, these move radially inwards and the circumferential surface 17 of the axial shoulder 16 moves closer to the stop ring 20 and finally rests thereon (indicated by broken lines in FIG. 2). Since the high pressure p₁ acts radially on the outside of the sealing ring 12, the radially cut packing ring 30, which is to this end advantageously of at least three-part construction, is then also carried along by the sealing ring 12 and pressed together with the sealing ring 12 against the component to be sealed and thus wears jointly with the sealing ring 12. Because of the then markedly enlarged contact surface, the rate of wear thereby slows down considerably, so achieving wear retardation. Thus, reliable functioning of the seal, at least for a certain period, may still be ensured even when the limit stop has already been reached.

The radially cut packing ring 30, in FIG. 3 a packing ring 30 with four packing ring segments 32, then needs to be arranged in such a way that the radial gaps 33 arising between the packing ring segments 32 are offset relative to the axial gaps 22 in the sealing ring 12, in order to seal the latter, as illustrated in FIG. 3. Between radially cut packing ring 30 and sealing ring 12 an antirotation element is advantageously also provided, in order to maintain the offset. The antirotation element may be a simple pin, which is pressed into aligned openings in the sealing ring 12 and in the stop ring 20. However, any other suitable antirotation element is also feasible. In an embodiment with parallel end faces 21, in which the back-up segments 13 retain their position, any antirotation element between sealing ring 12 and stop ring 20 is arranged particularly advantageously on one of the back-up segments 13, since the antirotation element is in this case subject to substantially no shear stress upon wear of the sealing segments 14 and thus the risk of breakage of the antirotation element is slight.

A further advantageous development of the invention is illustrated in FIGS. 6 and 7. Here the axial shoulder 16 of the sealing ring 12 is disposed on the low pressure p₂ side. In this case, a rigid, uncut back-up ring 40 rests axially against the low pressure p₂ side of the sealing ring 12 as the stop ring 20. The back-up ring 40 is here arranged between the sealing ring 12 and a wall of the packing housing 10 and takes on the task of radially sealing the sealing ring 12 against the high pressure p₁ prevailing in the packing chamber 3. The back-up ring 40 is in this case preferably wider than the length of the axial shoulder 16, as indicated in FIG. 7, so as to prevent a “double fit” which is unfavourable as regards manufacture. A resilient ring 41 is additionally arranged against the low pressure end face of the sealing ring 12, this being arranged radially between back-up ring 40 and axial shoulder 16. This resilient ring 41 is preferably spaced radially from the inner circumferential surface 17 of the axial shoulder 16 and may also be radially spaced from the outer circumferential surface 42 of the back-up ring 40. When the axial shoulder 16 reaches the resilient ring 41, further wear compresses the resilient ring 41, which slows down the rate of wear. As wear progresses, the resilient ring 41 also comes at some point to rest on the back-up ring 40, which further slows down the rate of wear. The rate of wear may thus be gradually reduced, until no further wear is possible. The wear retardation, brought about by the radial give of the resilient ring 41, may be adjusted by the radial height of and/or the material used for the resilient ring 41. It is also feasible, however, for the resilient ring 41 to rest from the outset against the axial shoulder 16, whereby the wear retardation arises from the outset.

Such a resilient ring 41 may of course also be used without any additional back-up ring 40 and in this case simultaneously forms the stop ring 20. In this case, the sealing ring 12 preferably lies for the purpose of radial sealing against the wall of the packing housing 10 and the resilient ring 41 is spaced radially from the axial shoulder 16.

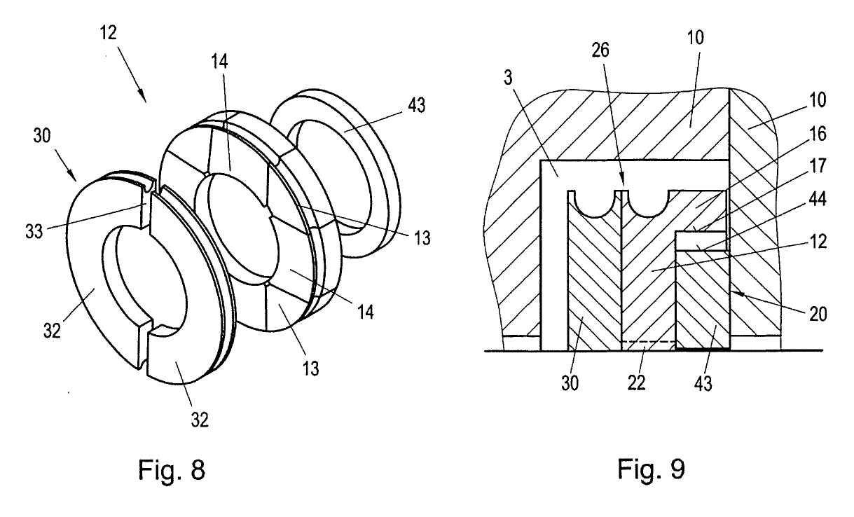

In a further advantageous development of the invention only a rigid back-up ring 43 is provided, as illustrated in FIGS. 8 and 9. Once the axial shoulder 16 rests as a result of wear against the outer circumferential surface 44 of the back-up ring 43, further wear of the sealing ring 12 is only possible by way of resilient deformation of the sealing ring 12, whereby a simple wear limit is provided.

Use of a radially cut packing ring 30, as described with regard to FIGS. 2 and 3 and 6 to 9, is not, however, limited only to developments with axial gaps 22 between the sealing segments 14 of the sealing ring 12. It is also possible for such a radially cut packing ring 30 to be used in the various arrangements in an embodiment of the sealing ring 12 according to FIG. 4, in particular and particularly advantageously in conjunction with an axial shoulder 16 facing the high pressure side, as described in FIGS. 2 and 3. In this case, a rigid back-up ring on the high pressure side could also be provided as the stop ring 20 instead of the radially cut packing ring 30.

The axial shoulder 16 of the sealing ring 12 does not of course have to be arranged in the radially outer area of the sealing ring 12, but rather may also for example be arranged in the middle or in the radially inner area, provided that it is initially arranged radially spaced from the stop ring 20. The radial spacing serves, primarily in association with wear retardation, substantially to allow a running-in phase, during which the sealing segments 14 may wear without hindrance and in this way become conformed to the component to be sealed. The radial spacing may preferably be between 0.5 mm and 2 mm.

The sealing ring 12 according to the invention, optionally in combination with a radially cut packing ring 30 and/or with a back-up ring 40, 43 and/or a resilient ring 41, is preferably used in a pressure packing 26. In this case, a plurality of such pressure packings 26 may also be arranged axially one behind the other to produce a seal 4, for example as in FIG. 1. It is also feasible, however, to use different packing rings or packing ring combinations in different pressure packings of the seal 4, e.g. an arrangement according to the invention (e.g. according to FIG. 2, 3 or 6 to 9) in the first pressure packings 26 and a conventional pressure packing 2 with radially and tangentially cut packing rings (e.g. according to FIG. 1) thereafter.

1. A packing ring combination with a sealing ring (12) consisting of a number of sealing segments (14) and back-up segments (13), the sealing and back-up segments (14, 13) being arranged next to one another alternately in the circumferential direction to form a ring, and with a stop ring (20) which rests axially against the sealing ring (12), wherein an axial shoulder (16) is provided on the sealing segments (14) of the sealing ring (12), which shoulder at least partially overlaps the stop ring (20) in the axial direction, and the axial shoulder (16) is arranged at a distance from the stop ring (20) in the radial direction, such that the axial shoulder (16) rests against the stop ring (20) once the sealing segments (14) have been worn by a given amount.

2. The packing ring combination according to claim 1, wherein the two end faces (21), viewed in the circumferential direction, of a sealing segment (14) are arranged parallel to one another.

3. The packing ring combination according to claim 2, including an antirotation element between sealing ring (12) and stop ring (20), the antirotation element being arranged on the sealing ring (12) on a back-up segment (13).

4. The packing ring combination according to claim 3, wherein the two end faces (21), viewed in the circumferential direction, of a sealing segment (14) are bevelled radially on the inside.

5. The packing ring combination according to claim 4, including a radially cut packing ring (30) which rests axially against the sealing ring (12).

6. The packing ring combination according to claim 5, wherein the radially cut packing ring (30) is simultaneously the stop ring (20).

7. The packing ring combination according to claim 5, including a rigid back-up ring (40, 43) as the stop ring (20).

8. The packing ring combination according to claim 7, including a radially-arranged resilient ring (41) between axial shoulder (16) and back-up ring (40).

9. The packing ring combination according to claim 5, including a resilient ring as the stop ring (20).

10. The packing ring combination according to claim 9, including an axial shoulder on the back-up segments (13), such that, together with the axial shoulders (16) of the sealing segments (14), a circumferentially continuous axial shoulder is produced.

11. The pressure packing consisting of a packing ring combination according to claim 1, which is arranged in a packing chamber (3) of a packing housing, wherein the packing ring combination provides a seal between a side with a high pressure (p₁) and a side with a low pressure (p₂).

12. The pressure packing according to claim 11, wherein the radially cut packing ring (30) rests axially against the sealing ring (12) on the high pressure (p₁) side.

13. The pressure packing according to claim 12, wherein the axial shoulder (16) is provided on the side of the sealing ring (12) facing the low pressure (p₂).

14. The pressure packing according to claim 13, including a rigid back-up ring (40, 43) as the stop ring (20), which back-up ring rests axially against the sealing ring (12) on the low pressure side.

15. The pressure packing according to claim 14, including a radially-arranged resilient ring (41) between axial shoulder (16) and back-up ring (40).

16. The pressure packing according to claim 13, including a resilient ring as the stop ring (20), which resilient ring rests axially against the sealing ring (12) on the low pressure side.

17. The pressure packing according to claim 11, wherein the axial shoulder (16) is provided on the side of the sealing ring (12) facing the high pressure (p₁).

18. The pressure packing according to claim 17, wherein the radially cut packing ring (30) is provided as the stop ring (20).

19. The pressure packing according to claim 17, including a rigid back-up ring as the stop ring (20), which back-up ring rests axially against the sealing ring (12) on the high pressure side.

20. A seal for providing a seal between a rigid component and a movable component, including a number of pressure packings arranged axially next to one another and in each case arranged in a packing housing, wherein at least one pressure packing (26) is constructed according to claim 11.
